(19) United States
(12) Patent Application Publication
(10) Pub. No.: US 2020/0081756 A1
(43) Pub. Date: Mar. 12, 2020

(54) Failure Mode Estimation System

(71) Applicant: Hitachi, Ltd., Tokyo (JP)

(72) Inventors: Takayuki UCHIDA, Tokyo (JP); Tomoaki HIRUTA, Tokyo (JP); Toshiaki KONO, Tokyo (JP); Yasuharu NAMBA, Tokyo (JP)

(21) Appl. No.: 16/293,292

(22) Filed: Mar. 5, 2019

(30) Foreign Application Priority Data
Sep. 7, 2018 (JP) 2018-167562

(51) Int. Cl. G06F 11/00; G06N 7/00; G06F 16/23; G06F 11/07

(52) U.S. Cl. CPC G06F 11/008; G06F 11/0775; G06F 16/23; G06N 7/005

(57) ABSTRACT

Provided is a failure mode estimation system for estimating a failure mode of a device based on an inputted state of the device. The failure mode estimation system includes: a failure mode estimation unit that estimates a failure mode of the device on the basis of the inputted state of the device and a table in which correspondence between a failure mode of the device and an estimation standard is registered; and an update unit that updates the estimation standard registered in the table when a failure mode estimated by the failure mode estimation unit is incorrect.

### CLAIM OF PRIORITY

The present application claims priority from Japanese Patent application serial no. 2018-167562 filed on Sep. 7, 2018, the content of which is hereby incorporated by reference into this application.

### BACKGROUND OF THE INVENTION

### 1. Field of the Invention

The present invention relates to a failure mode estimation system for assisting a maintenance work of a device by a maintenance worker, by estimating and notifying a failure mode of a stopped device.

### 2. Description of the Related Art

Maintenance work for maintaining a normal condition of a device is indispensable for devices required with continuous operation for a long time such as gas engines, elevators, mining equipment, construction equipment, and pumps. In addition, when the device fails and stops, it is required to promptly investigate a cause of the failure and take countermeasures (cleaning, parts replacement, repair, and the like) according to the cause of the failure. In investigating the cause of failure, it is particularly of importance to check a state of each part of the device and correctly specify a failure type (hereinafter referred to as “failure mode”) of the device in order to take appropriate countermeasures.

Here, as an invention that has automated specification of a failure mode, the invention described in JP 2009-223362 A is known. The abstract of JP 2009-223362 A describes “a processing process of software of an image forming apparatus is recorded (S300), a log in response to the occurrence of a fault is acquired (S302 and S304), and a sub cause and effect network is created (S320) and held (S330). A management center collects the sub cause and effect network of each image forming apparatus periodically (S331 to S336). The collected sub cause and effect networks are classified by a model, embedded into an existing diagnostic model by a model to optimize the diagnostic model, and presented to the relevant devices (S360, S361, and S370). The image forming apparatus performs diagnosis by applying a received aptitude diagnostic model (S380)”.

As described above, JP 2009-223362 A introduces a technique for estimating what kind of failure mode is occurring from a probability, with use of a model in which a failure probability is defined for each state of each part of the device and for each operation history of a user who uses the device. Then, there is disclosed a technique capable of temporary update in accordance with an actual situation of a failure situation in a market by setting a failure probability from knowledge and experience of a designer of a device and reliability information, and by updating an occurrence probability of a failure mode whose occurrence frequency exceeds a certain value.

### SUMMARY OF THE INVENTION

However, since JP 2009-223362 A is for updating a diagnostic model of a failure mode whose occurrence frequency exceeds a certain threshold value, a considerable time (e.g., one year) may be required for updating a diagnostic model of a failure mode with a low occurrence frequency.

Therefore, even if the technique of JP 2009-223362 A is used, it is not possible to improve a specification accuracy for all failure modes, and the diagnostic model is left unused for a long period of time without being updated in a case where an initial value of a diagnostic model of a failure mode with a low occurrence frequency is inaccurate. This causes a problem that a failure mode corresponding to such a diagnostic model is left untouched for a long period of time with a low specification accuracy.

Therefore, in the present invention, there is provided a failure mode estimation system capable of improving an estimation accuracy for a failure mode regardless of an occurrence probability of the failure mode, by appropriately improving a diagnostic model when failure mode estimation fails.

In order to solve the above problem, a failure mode estimation system of the present invention estimates a failure mode of a device on the basis of an inputted state of the device. Further, the failure mode estimation system includes: a failure mode estimation unit that estimates a failure mode of the device on the basis of the inputted state of the device and a table in which correspondence between a failure mode of the device and an estimation standard is registered; and an update unit that updates the estimation standard registered in the table when a failure mode estimated by the failure mode estimation unit is incorrect.

According to the present invention, there is provided a failure mode estimation system capable of improving an estimation accuracy for a failure mode regardless of an occurrence probability of the failure mode, by appropriately improving a diagnostic model when failure mode estimation fails.

### BRIEF DESCRIPTION OF THE DRAWINGS

FIG. 1 is a schematic configuration diagram of a failure mode estimation system of one embodiment;

FIG. 2 is a data structure view of a failure probability table of one embodiment;

FIG. 3 is a data structure view of an assumed condition table of one embodiment;

FIG. 4 is a data structure view of a device management table of one embodiment;

FIG. 5 is a data structure view of a probability update table of one embodiment;

FIG. 6 is a flowchart showing a main routine of a failure mode estimation system of one embodiment;

FIG. 7 is a flowchart of a subroutine called from the main routine in FIG. 6;

FIG. 8 is a flowchart of a subroutine called from the main routine in FIG. 6;

FIGS. 9A to 9C are temporary data structure views to be used in a failure mode estimation system of one embodiment;

FIGS. 10A and 10B are temporary data structure views to be used in a failure mode estimation system of one embodiment;

FIGS. 11A and 11B are screen examples to be used in a failure mode estimation system of one embodiment;

FIG. 12 is a screen example to be used in a failure mode estimation system of one embodiment; and

FIG. 13 is a screen example to be used in a failure mode estimation system of one embodiment.

### DESCRIPTION OF THE PREFERRED EMBODIMENTS

Hereinafter, a failure mode estimation system 10 according to one embodiment of the present invention will be described with reference to the drawings.

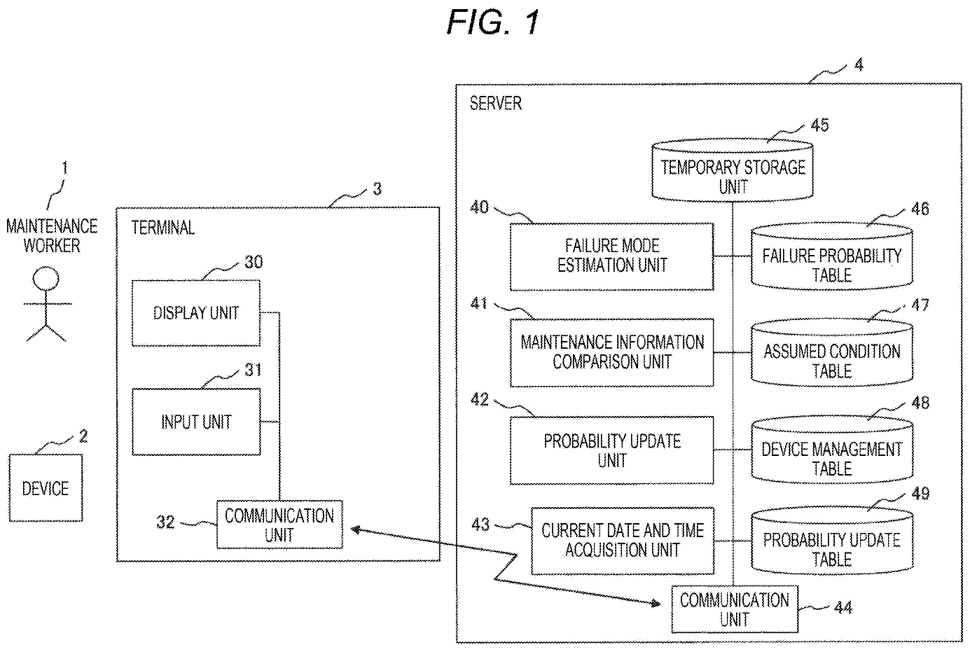

FIG. 1 is a schematic configuration diagram of the failure mode estimation system 10. The failure mode estimation system 10 is a system to notify a maintenance worker 1 at a site, of an estimation result of the failure mode of a stopped device 2. The failure mode estimation system 10 mainly includes a terminal 3 to be operated by the maintenance worker 1, and a server 4 connected to the terminal 3 via a public line and the like. FIG. 1 shows an example assuming that the terminal 3 is carried at the site by the maintenance worker 1, and the server 4 is installed in a management center or the like at a remote location. However, each function of the server 4 shown in FIG. 1 may be incorporated in the terminal 3.

The device 2 is any maintenance target device such as a generator, construction machinery, or a medical device that is required to be continuously driven for a long time. Hereinafter, a description is given on assumption that the device 2 is a pump, and a failure mode to be estimated is “abnormal vibration in bearing”, “impeller failure”, “seal leakage”, and the like. When the device 2 stops, the maintenance worker 1 can obtain an estimation result of a failure mode by the server 4, by checking a state of each part of the device 2 and inputting the result to the terminal 3 described later. Although FIG. 1 illustrates a configuration in which the device 2 and the terminal 3 are separated, the device 2 may incorporate the terminal 3.

The terminal 3 is a lightweight tablet or the like that the maintenance worker 1 can easily carry, and is provided with a display unit 30 such as a liquid crystal display, an input unit 31 such as a touch display, and a communication unit 32 that communicates with the server 4 via a public line.

The server 4 receives a check result of the device 2 inputted to the terminal 3 by the maintenance worker 1, estimates the failure mode of the device 2 on the basis of the check result, and then returns the estimation result to the terminal 3. Further, if the estimation result is incorrect, the server 4 improves an estimation accuracy for subsequent failure modes by correcting the estimation standard such as “failure probability” in a diagnostic model used for estimating the failure mode, on the basis of a correct failure mode provided from the maintenance worker 1.

This server 4 includes, as shown in FIG. 1, a failure mode estimation unit 40, a maintenance information comparison unit 41, a probability update unit 42, a current date and time acquisition unit 43 such as a clock, a communication unit 44 that communicates with the terminal 3 via a public line, and a temporary storage unit 45 including a RAM and the like to temporarily store data. The server 4 stores, in a storage device (not shown), a diagnostic model including a failure probability table 46 defining an association between a check item of a state of the device 2 and a failure probability, an assumed condition table 47 storing an assumed condition when the failure probability is defined, a device management table 48 storing an installation date and installation environment of the device 2, a probability update table 49 storing information to be a reference for updating the probability, and the like.

The server 4 is actually a computer including a computing device such as a CPU, a main storage device such as a semiconductor memory, an auxiliary storage device such as a hard disk, and hardware such as a communication device. Then, each function of the above-described failure mode estimation unit 40 and the like is realized by the computing device executing the program loaded in the main storage device while referring to a database recorded in the auxiliary storage device. In the description below, such known technologies are appropriately omitted.

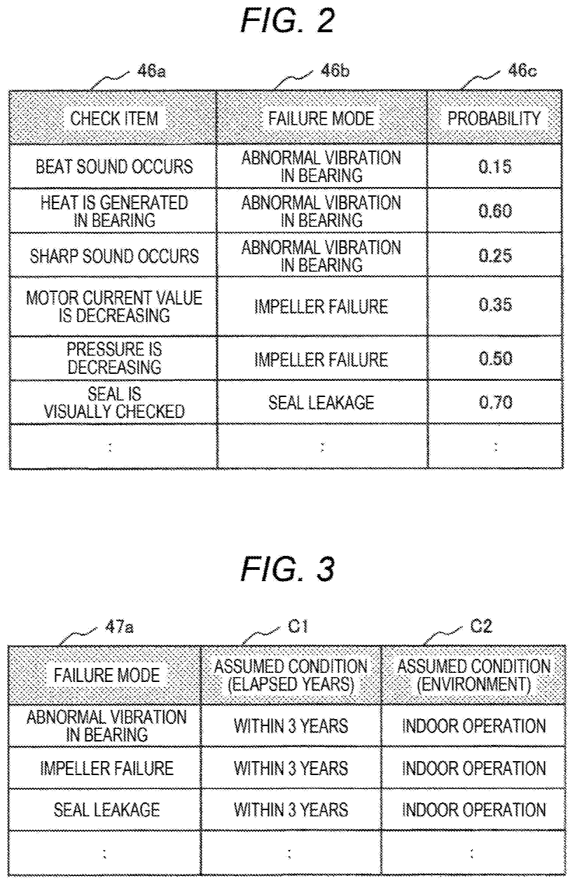

Next, with reference to FIGS. 2 to 5, a description will be given to each data structure of the failure probability table 46, the assumed condition table 47, the device management table 48, and the probability update table 49 that constitute the diagnostic model in the present embodiment.

FIG. 2 is a data structure view of the failure probability table 46. A check item 46a corresponds to a state of each part of the device 2, which will be a clue for determining the failure mode of the device 2. Each check items 46a is associated with a failure mode 46b and a probability 46c (first estimation standard) indicating a weight of a clue. Using this table allows the failure mode estimation unit 40 to estimate which failure mode is more likely to occur from a total value of the probability 46c in a row of the check item 46a corresponding to a state of the device 2. Note that each of the check item 46a, the failure mode 46b, and the probability 46c is defined by the designer or the like of the device 2 at a time of designing the failure mode estimation system 10.

FIG. 3 is a data structure view of the assumed condition table 47. The assumed condition table 47 defines the failure mode 46b of the device 2 and assumed conditions C1 and C2 that have been assumed by the designer or the like in defining the probability 46c of the failure probability table 46. In the present embodiment, the assumed conditions C1 and C2 respectively are a use period (elapsed years) of the device 2 and an installation location (environment) of the device 2, and for example, the first row of a failure mode 47a “abnormal vibration in bearing” indicates that each value of the probability 46c in FIG. 2 has been defined on the assumption of the device 2 having the elapsed years of within 3 years and being operated indoors. While the assumed conditions are two of “elapsed years” and “environment” in the example of FIG. 3, any of parameters such as “elapsed years”, “environment”, “temperature”, “humidity”, and “number of activation times per day” may be combined and used in accordance with a type of the device 2.

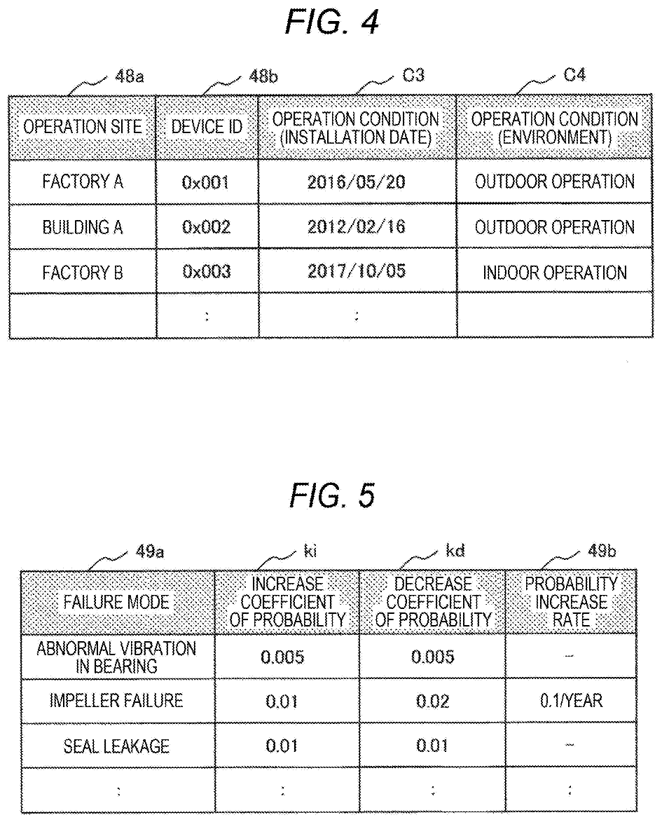

FIG. 4 is a data structure view of the device management table 48. The device management table 48 is a table storing an operation site 48a, a device ID 48b, an operation condition C3 (installation date), and an operation condition C4 (environment) for each of the devices 2 operating at various sites (places), and is a table to be used in calculating a difference between the assumed conditions C1 and C2 assumed by the failure probability table 46 and the actual operation conditions C3 and C4 of the device 2. Providing this table allows the server 4 to calculate the number of differences between the assumed conditions and the operation conditions simply by the maintenance worker 1 selecting the site visited by the maintenance worker 1 and a device ID of the maintenance target, from the terminal 3. In the present embodiment, a configuration in which the server 4 has this table is illustrated, but the maintenance worker 1 may visually observe an actual operation environment of the device 2 and input information corresponding to this table from the terminal 3.

FIG. 5 is a data structure view of the probability update table 49. This table is a table to be used for improving an estimation accuracy for subsequent failure modes when a failure mode estimated by the failure mode estimation system 10 is incorrect, and is a table that records an increase coefficient ki of a probability, a decrease coefficient kd of a probability, and a probability increase rate 49b (second estimation standard) for each failure mode 49a. As shown in the “impeller failure” in the second row of the failure mode 49a, the probability increase rate 49b is registered as “0.1/year” in advance at the time of designing this system, for a failure mode known that the failure probability increases with elapsed years. Whereas, the probability increase rate 49b is not registered for a failure mode in which a failure occurs randomly regardless of elapsed years, such as “abnormal vibration in bearing” in the first row of the failure mode 49a or “seal leakage” in the third row.

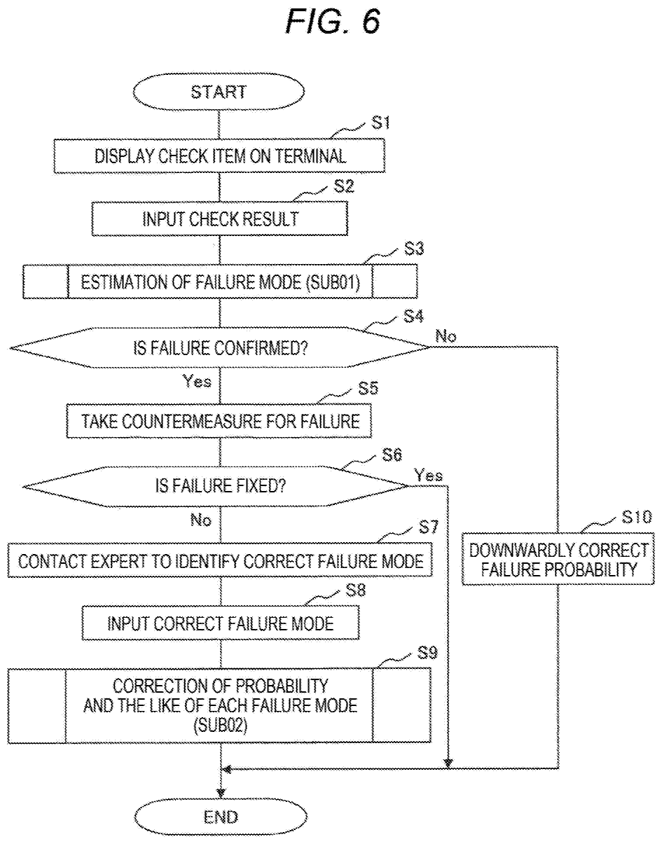

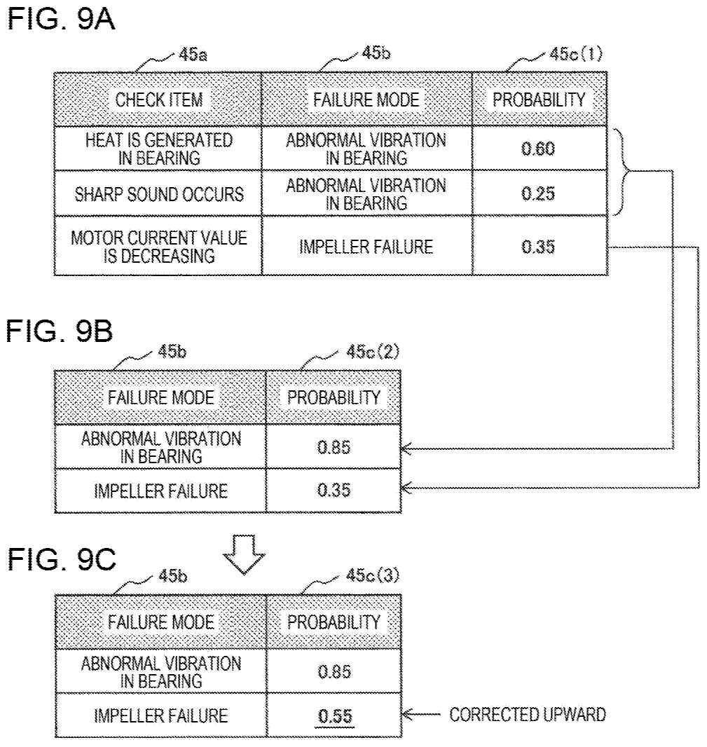

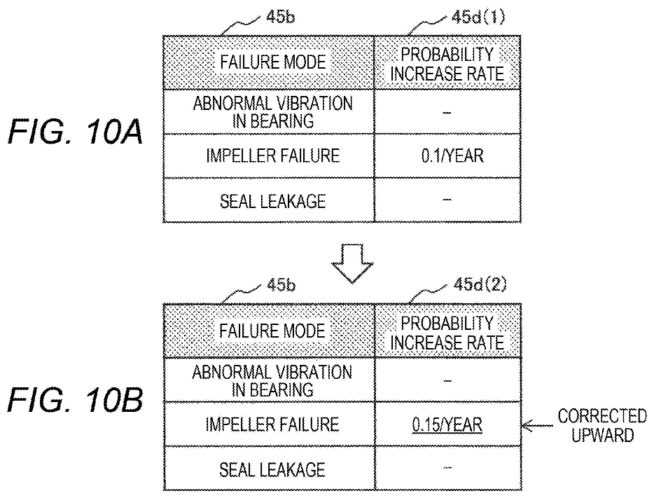

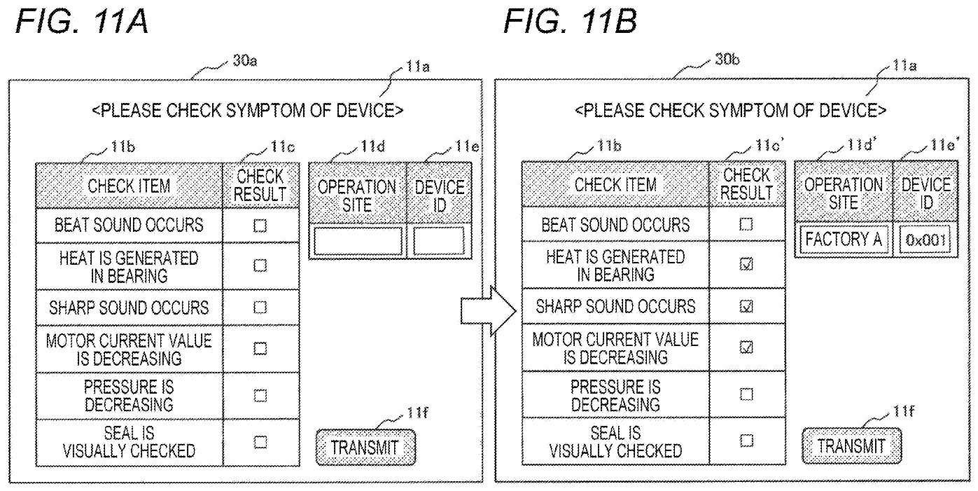

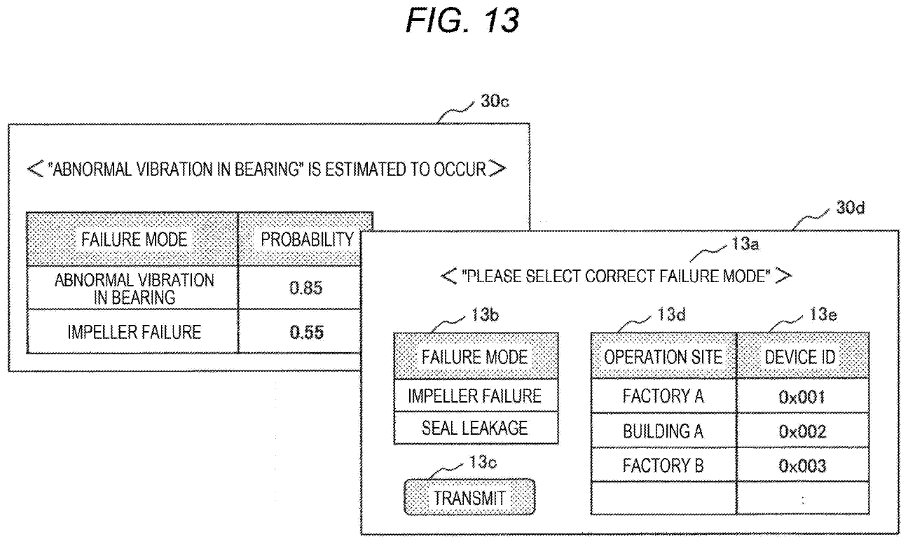

Next, a description will be given to a method in which the failure mode estimation system 10 estimates a failure mode of the device 2 on the basis of each table described above after the maintenance worker 1 visits the operation site of the stopped device 2, and details on a method for correcting the diagnostic model in a case where the estimation result is incorrect, with reference to the flowcharts of FIGS. 6 to 8, data in the temporary storage unit 45 of FIGS. 9A to 9C and FIGS. 10A and 10B, and display screen examples of FIGS. 11A and 11B and 13.

First, the flowchart of FIG. 6 will be described. In step S1, a check item 11b as illustrated in a display example 30a of FIG. 11A is displayed on the display unit 30 of the terminal 3 so as to allow the maintenance worker 1 to input a state of each part of the stopped device 2. This is obtained by reading out the check item 46a of the failure probability table 46. In this way, the display unit 30 displays, in addition to a column of the check item 11b, a field of an instruction 11a to the maintenance worker 1, a column of a check box 11c adjacent to the column of the check item 11b, an operation site input field 11d, a device ID input field 11e, and a transmission button 11f.

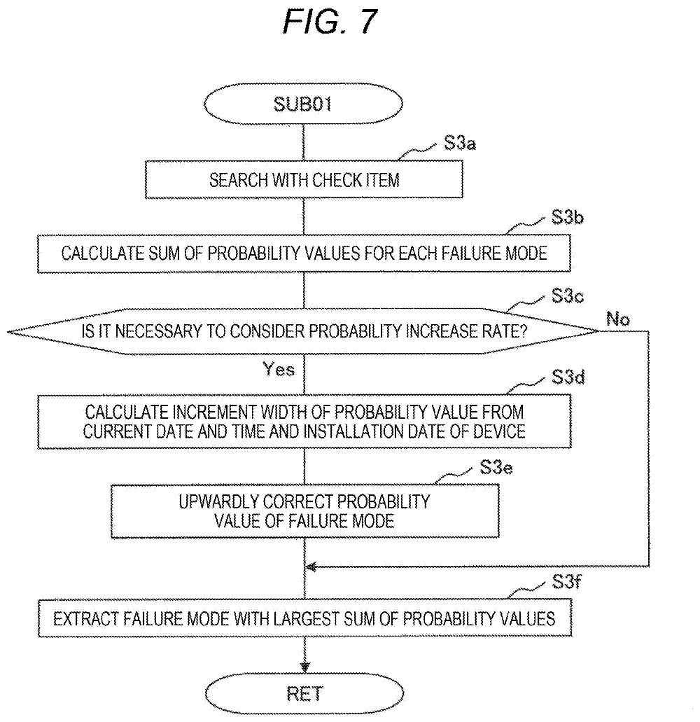

In step S2, the maintenance worker 1 inputs a check result according to the state of the device 2. For example, the maintenance worker 1 checks as shown in a check box 11c′ of a display example 30b of FIG. 11B, when a state seen in the device 2 is “heat is generated in bearing”, “sharp sound occurs”, and “motor current value is decreasing”. In addition, the operation site visited by the maintenance worker 1 and the device ID with the state checked are also inputted to the operation site input field 11d and the device ID input field lie a. When all the inputs are completed, the transmission button 11f is pressed and the process proceeds to the next. In step S3, the failure mode estimation unit 40 executes a subroutine SUB01 for estimating the failure mode on the basis of the information inputted by the maintenance worker 1 in step S2. Details of this subroutine SUB01 will be described with reference to FIG. 7.

First, in step S3a, the failure probability table 46 is searched with the check box 11c′ inputted in step S2 as a search key. Specifically, a check item checked by the maintenance worker 1 (checked in the column of the check box 11c′ in FIG. 11B) is searched among the check items 46a of the failure probability table 46, and the failure mode 46b and the probability 46c of these are acquired and temporarily stored in the temporary storage unit 45. An example thereof is shown in FIG. 9A. This example is a table to be created when three check items “heat is generated in bearing”, “sharp sound occurs”, and “motor current value is decreasing” are checked, and is a table in which a failure mode 45b corresponding to each check item 45a and a probability 45c (1) is registered.

In step S3b, the probability values temporarily stored in the temporary storage unit 45 are summed for each failure mode. For example, in a case where a table of FIG. 9A is temporarily stored, the table is temporarily stored as a table as shown in FIG. 9B, by obtaining “0.85”, which is a total value of two failure probabilities “0.60” and “0.25”, for the failure mode “abnormal vibration in bearing”, and by setting the single failure probability “0.35” as the total value as it is for the failure mode “impeller failure”.

In step S3c, it is determined whether or not a failure mode with a probability value increasing with elapsed years is included in the extracted failure modes. Specifically, with the failure mode 45b in the table of FIG. 9B as a search key, it is determined by whether or not a value is registered in the probability increase rate 49b of the probability update table 49. When the value is registered, the process proceeds to step S3d, otherwise proceeds to step S3f. In the example of FIG. 9B, a value of the probability increase rate 49b is not registered for the failure mode “abnormal vibration in bearing”, and a value is registered for the failure mode “impeller failure”.

When the value of the probability increase rate 49b is registered, the elapsed years of the device 2 is multiplied by the increase rate 49b to calculate an increment width of the failure probability, in step S3d. For this purpose, firstly, the maintenance worker 1 acquires the installation date of the device 2 from the operation condition C3 of the device management table 48, with the operation site and the device ID inputted in FIG. 11B as search keys. Next, by subtracting the installation date from the current date and time obtained from the current date and time acquisition unit 43, the elapsed years of the device 2 can be obtained. For example, on the basis of the device ID=0x001, if the installation date of the device 2 is found to be 20 May 2016, the elapsed years is “2 years” when the current date is May 20, 2018. By multiplying “2 years” by “0.1/year”, which is the probability increase rate 49b of the failure mode “impeller failure”, the increment width “0.2” of the failure probability can be calculated.

In step S3e, the increment width obtained in step S3d is added to the corresponding failure mode in the table of FIG. 9B. In the example of FIG. 9B, by adding the increment width “0.2” to the probability value “0.35” of the failure mode “impeller failure”, it is possible to obtain the table of FIG. 9C in which the failure probability of the failure mode “impeller failure” is corrected upward to “0.55”.

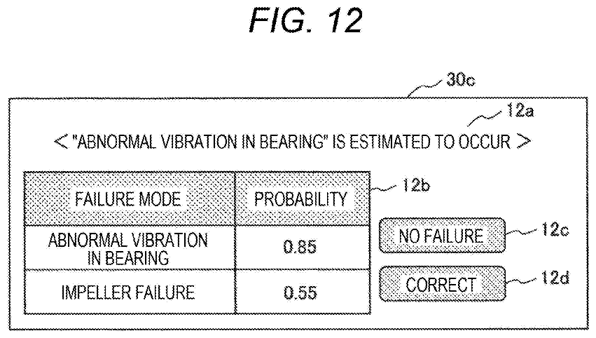

In step S3f, a failure mode with the largest sum of the probability values is extracted and presented as an estimation result of the failure mode. In the example of FIG. 9C, the probability value “0.85” of the failure mode “abnormal vibration in bearing” is compared with the probability value “0.55” of the failure mode “impeller failure”, and the failure mode “abnormal vibration in bearing” having the maximum failure probability “0.85” is presented as the estimation result of the failure mode, in an estimation result display field 12a in a display example 30c of FIG. 12. Then, the subroutine SUB01 of FIG. 7 is ended, and the process proceeds to step S4 of the main routine of FIG. 6.

In step S4, the maintenance worker 1 determines whether a fault has occurred in the device 2 in the first place. When the failure has not been confirmed, a button 12c of the display example 30c in FIG. 12 is pressed and the process proceeds to step S10. Whereas, if a failure can be confirmed, the process proceeds to step S5.

In step S10, the probability update unit 42 downwardly corrects the probability 46c registered in the failure probability table 46 by a predetermined decrement width. This is because the probability 46c is considered to be too high in a case where the failure mode has not been actually confirmed despite the failure mode estimated by the failure mode estimation unit 40. The decrement width of the probability 46c is calculated for each checked item as follows, with use of the decrease coefficient kd registered in the probability update table 49.

Decrement width=decrease coefficient kd×(number of mismatches between assumed condition and operation condition) (Expression 1)

In Expression 1, the decrease coefficient kd may be the same in the check items of the same failure mode. For example, in a case of downward correction of the probability of the failure mode “abnormal vibration in bearing” presented in the estimation result display field 12a of the display example 30c of FIG. 12, (assumed conditions C1, C2)={within 3 years, indoor operation} is obtained from the assumed condition table 47 of FIG. 3, and (elapsed years calculated from the operation condition C3, the operation condition C4)={2 years, outdoor operation} is obtained from the device management table 48 of FIG. 4, in a case where device ID=0x001. From these, (a mismatch between the assumed condition C1 and the elapsed years calculated from the operation condition C3, and between the assumed condition C2 and the operation condition C4) can be determined to be the environment alone, and the number of mismatches is “1”. Further, since the decrease coefficient kd=0.005 corresponding to the failure mode “abnormal vibration in bearing” can be obtained from the probability update table 49 in FIG. 5, the decrement width of the downward correction can be obtained by the following Expression 2 in this example.

Decrement width of failure mode “abnormal vibration in bearing”=0.005×1=0.005 (Expression 2) This decrement width “0.005” is subtracted from, in this example, the probability values “0.60” and “0.25” of “heat is generated in bearing” and “sharp sound occurs” among the probability 46c of the failure probability table 46 in FIG. 2, and “0.595” and “0.245” after downward correction are registered in the failure probability table 46 as new probability values. In a case where failure has not been confirmed, the main routine of FIG. 6 is ended when the process of step S10 is completed, that is, the downward correction of the probability 46c in the failure probability table 46 is completed. As it is obvious from Expression 1, in a case where all the assumed conditions and the operation conditions match, the probability 46c will not be downwardly corrected even when the process proceeds to step S10.

Whereas, when a failure can be confirmed in step S4, the maintenance worker 1 applies, to the device 2, a countermeasure (cleaning, parts replacement, repair, or the like) required for fixing the failure, on the basis of the failure mode (e.g., “abnormal vibration in bearing”) estimated by the failure mode estimation unit 40, in step S5. Since it is possible to check what kind of countermeasure is required from a maintenance work manual and the like on the basis of the estimated failure mode, even an unskilled maintenance worker 1 can implement an appropriate countermeasure according to the failure mode.

Thereafter, in step S6, the maintenance worker 1 determines whether or not the failure of the device 2 has been fixed as a result of the countermeasure specified in the maintenance work manual or the like. When the device 2 is fixed, it can be determined that the failure mode estimated by the failure mode estimation unit 40 is appropriate, and it is not necessary to modify the failure probability table 46. Therefore, the main routine is ended with the current failure probability table 46 maintained as it is. Whereas, when the device 2 has not been fixed by the countermeasure applied in step S5, it can be determined that the failure mode estimated by the failure mode estimation unit 40 is incorrect, and it is required to correct the failure probability table 46 that has led to the incorrect conclusion. Therefore, the process proceeds to step S7 and the subsequent steps in order to correct the probability 46c of the failure probability table 46.

First, in step S7, the maintenance worker 1 estimates a failure mode that is considered to be correct, without relying on this system. For example, an experienced maintenance worker 1 may estimate the correct failure mode by investigating the device 2 in detail, while an unskilled maintenance worker 1 may estimate the correct failure mode while consulting with an expert on a telephone or the like.

In step S8, the maintenance worker 1 sends the failure mode estimated in step S7 to the server 4 via the terminal 3. For this purpose, the maintenance worker 1 presses a button 12d of the display example 30c of FIG. 12 to start the correction of the failure mode. First, pressing the button 12d causes a window like a display example 30d in FIG. 13 to be overlapped and displayed, and allows a correct failure mode to be inputted. “Please select the correct failure mode” is displayed in a work contents display field 13a of the display example 30d, and the failure mode other than the estimation result of the failure mode estimation unit 40 is listed in a failure mode selection field 13b. Therefore, the maintenance worker 1 selects the failure mode estimated in step S7 from the failure mode selection field 13b, and presses a transmission button 13c. Upon completion, the process proceeds to step S9. Note that, in the display example 30d of FIG. 13, a list of an operation site 13d and a device ID 13e created on the basis of the device management table 48 is also displayed as reference information, but this list may not be displayed.

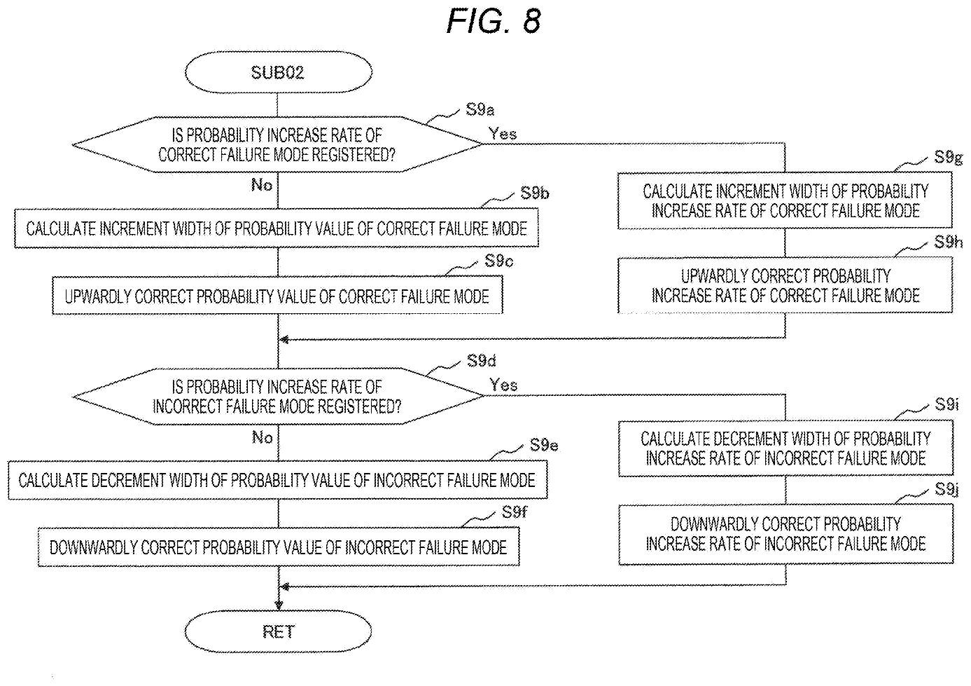

In step S9, the maintenance information comparison unit 41 and the probability update unit 42 execute a subroutine SUB02 for correcting the probability of the failure mode on the basis of the failure mode inputted in step S8. This subroutine SUB02 will be described with reference to FIG. 8.

First, in step S9a, it is determined whether or not the correct failure mode inputted by the maintenance worker 1 is a failure mode in which the probability value increases with elapsed years. This can be determined by whether or not a value is present in the increase rate 49a of the probability of the correct failure mode, in the probability update table 49. When the value is present, the process proceeds to step S9g, otherwise proceeds to step S9b.

In a case where the correct failure mode is a failure mode in which the probability value does not increase with the elapsed years, the increment width for upward correction of the probability of the correct failure mode is calculated by the following Expression 3, in step S9b. This is the same calculation method as Expression 1 in step S10, merely with the decrease coefficient kd changed to the increase coefficient ki.

Increment width=increase coefficient ki×(number of mismatches between assumed condition and operation condition) (Expression 3)

In step S9c, the increment width obtained in step S9b is added to a value of the row of the check item associated with the correct failure mode, among the probability 46c of the failure probability table 46 in FIG. 2. For example, when the correct failure mode estimated in step S7 is “seal leakage”, upward correction is performed for adding the increment width obtained by Expression 3 to the probability such as the check item “seal is visually checked” corresponding to the failure mode “seal leakage”.

Whereas, in a case where the correct failure mode is a failure mode in which the probability value increases with elapsed years, the increment width of the probability increase rate 49b of the probability update table 49 of FIG. 5 is calculated by Expression 3 in steps S9g and S9h instead of the probability 46c of the failure probability table 46 of FIG. 2, and the corresponding probability increase rate 49b is corrected upward as illustrated in FIGS. 10A and 10B by using the increment width. Since the processing in steps S9g and S9h is substantially the same as the processing in steps S9b and S9c, the detailed description will be omitted.

Next, in step S9d, it is determined whether or not an incorrect failure mode estimated by the failure mode estimation unit 40 is a failure mode in which the probability value increases with elapsed years. This can be determined by whether a value is present in the increase rate 49a of the incorrect failure mode, in the probability update table 49. When the value is present, the process proceeds to step S9i, otherwise proceeds to step S9e.

In a case where the incorrect failure mode is a failure mode in which the probability value does not increase with elapsed years, a decrement width for downward correction of the probability of the incorrect failure mode is calculated in step S9e. This is the same calculation method as Expression 1 in step S10.

In step S9f, the decrement width obtained in step S9e is subtracted from a value of the row of the check item associated with the incorrect failure mode, among the probability 46c of the failure probability table 46 in FIG. 2.

Whereas, in a case where the incorrect failure mode is a failure mode in which the probability value increases with elapsed years, the decrement width of the probability increase rate 49b of the probability update table 49 of FIG. 5 is calculated by Expression 1 in steps S9i and S9j instead of the probability 46c of the failure probability table 46 of FIG. 2, and the corresponding probability increase rate 49b is corrected downward by using the decrease width. Since the processing in steps S9i and S9j is substantially the same as the processing in steps S9e and S9f, the detailed description will be omitted.

The subroutine SUB02 in FIG. 8 is completed by termination of the downward correction in step S9f or the downward correction in step S9j, and the process returns to the main routine. Since the subroutine SUB02 in FIG. 8 is also the last step S9 of the main routine, the main routine is also ended with the completion of the process in FIG. 8.

As described above, when the failure mode estimation unit 40 estimates an incorrect failure mode, the probability 46c of the failure probability table 46 or the probability increase rate 49b of the probability update table 49 corresponding to the incorrect failure mode is corrected downward, and the probability 46c of the failure probability table 46 or the probability increase rate 49b of the probability update table 49 corresponding to the correct failure mode inputted by the maintenance worker 1 is corrected upward, by performing the processing of the flowcharts of FIGS. 6 to 8. This allows the failure probability table 46 or the probability update table 49 to be improved each time an error in estimation by the failure mode estimation unit 40 is found, improving the failure mode estimation accuracy by the failure mode estimation unit 40 so as to be proportional to the use period of the failure mode estimation system 10. As a result, as the use period of the failure mode estimation system 10 is longer, a more accurate estimation result is reported to the maintenance worker 1, enabling appropriate countermeasures to be promptly taken.

That is, according to the failure mode estimation system of the present embodiment, it is possible to improve a specification accuracy for a failure mode regardless of an occurrence probability of the failure mode, by appropriately improving a diagnostic model when failure mode estimation fails.

1. A failure mode estimation system for estimating a failure mode of a device based on an inputted state of the device,
the failure mode estimation system comprising:
a failure mode estimation unit that estimates a failure mode of the device based on the inputted state of the device and a table in which correspondence between a failure mode of the device and an estimation standard is registered; and
an update unit that updates the estimation standard registered in the table when a failure mode estimated by the failure mode estimation unit is incorrect.

2. The failure mode estimation system according to claim 1, wherein
an estimation standard relating to an incorrect failure mode is corrected downward when a failure mode estimated by the failure mode estimation unit is incorrect.

3. The failure mode estimation system according to claim 1, wherein
an estimation standard relating to a correct failure mode is corrected upward when a failure mode estimated by the failure mode estimation unit is incorrect.

4. The failure mode estimation system according to claim 1, wherein
the table is a failure probability table in which correspondence between a state of the device, a failure mode, and a failure probability is registered; and
an estimation standard updated by the update unit is the failure probability.

5. The failure mode estimation system according to claim 1, wherein
the table is a probability update table in which correspondence between a failure mode of the device and an increase rate of a failure probability with elapsed years of the device is registered; and
an estimation standard updated by the update unit is the increase rate.

6. The failure mode estimation system according to claim 1, wherein
the failure mode estimation system comprises a terminal and a server;
the terminal has a display unit, an input unit, and a communication unit; and
the server has a storage unit that stores the table, the failure mode estimation unit, the update unit, and a communication unit.

7. The failure mode estimation system according to claim 6, wherein
a failure mode estimated by the failure mode estimation unit is displayed on the display unit of the terminal;
a correct failure mode is inputted from the input unit of the terminal when a failure mode estimated by the failure mode estimation unit is incorrect.
